(19) United States
(12) Patent Application Publication
(10) Pub. No.: US 2013/0217289 A1
(43) Pub. Date: Aug. 22, 2013

(54) SUPER CAPACITOR THREAD, MATERIALS AND FABRICATION METHOD

(71) Applicants: Munir H. Nayfeh, Urbana, IL (US); Sui-Tung Yau, Cleveland, OH (US); Ammar M. Nayfeh, Masdar City (AE)

(72) Inventors: Munir H. Nayfeh, Urbana, IL (US); Sui-Tung Yau, Cleveland, OH (US); Ammar M. Nayfeh, Masdar City (AE)

(73) Assignee: NanoSi Advanced Technologies, Inc., Champaign, IL (US)

(21) Appl. No.: 13/611,966

(22) Filed: Sep. 12, 2012

Related U.S. Application Data
(60) Provisional application No. 61/534,130, filed on Sep. 13, 2011.

(51) Int. Cl. H01G 11/30

(52) U.S. Cl. CPC H01G 11/30
USPC 442/301; 361/502; 427/80; 442/304

(57) ABSTRACT

A one-dimensional super capacitor thread has thin conductive wire electrode. An active layer of silicon nanoparticles and polyaniline surrounds the electrode. An electrolyte layer surrounds the active layer. The electrolyte layer can be a layer of polyvinyl alcohol (PVA). A super capacitor can be formed with two or more of the threads, such as in a twisted pair configuration. The dimensions of the super capacitor can approximate standard threads used in clothing, for example.

### PRIORITY CLAIM AND REFERENCE TO RELATED APPLICATION

The application claims priority under 35 U.S.C. §119 from prior provisional application Ser. No. 61/534,130, which was filed Sep. 13, 2011.

### FIELD

This invention relates generally to the field of devices and materials for energy and electronics, and particularly super capacitors (a.k.a. electric double layer capacitors or electrochemical double layer, or ultracapacitors). More particular embodiments of the invention relate to fiber-based super capacitors.

### BACKGROUND OF THE INVENTION

A capacitor is an energy storage device. Capacitors serve as circuit elements and also provide the basis for batteries. Conventional electrolytic capacitors have to be extremely large to store significant energy for a power load as the electrolyte breakdown properties and plate separation limit the storage capacity of the devices. Super-capacitors are of interest for energy storage devices that provide energy densities that are typically hundreds of times greater than that of electrolytic capacitors. Super-capacitors serve as primary energy devices. Super-capacitors rely upon an electrical double layer to separate charge and require no bulky dielectric. High-surface areas can therefore be packaged in small volumes to achieve high capacitances.

Commercially available super-capacitors are used in alternative energy applications, such as to store power for vehicle systems and power grid applications. In recent years, electrochemical super capacitors have attracted significant attention as novel energy-storage devices because of their high power density, long life cycles, and high efficiency. Super capacitors can deliver higher power than batteries and store more energy than conventional capacitors. Maxwell Technologies has a product line of super-capacitors for various applications. The super capacitors have higher power density but are fairly bulky and have the physical form of other types of batteries.

Most current research on super capacitors has focused on their applications in electric vehicles, hybrid electric vehicles, and backup energy sources. Thus, conventional super capacitors are heavy and bulky, and it is still a challenge to achieve high efficiency miniaturized energy-storage devices, for instance, that are compatible with flexible/wearable electronics.

Planar super capacitors have been developed using two dimensional substrates such as carbon paper sheet or plastic sheets. These sheets can be stacked to form compact, small area devices. Fiber-based electrochemical micro super capacitors have also been developed using particular materials. In one example, ZnO-based nano wires are used as electrodes. See. e.g., Bae et al, “Fiber Supercapacitors Made of Nanowire-Fiber Hybrid Structures for Wearable/Flexible Energy Storage,” Angew. Chem. Int. Ed. 2011, 50, 1-6. These fiber super capacitors comprise two electrodes that employ a flexible plastic wire and a Kevlar fiber as a substrate. Both the wire and the fiber are covered with arrays of high-quality ZnO nano wires grown by the hydrothermal method, and ZnO nano wires on a Kevlar fiber are coated with a thin gold film.

In another example, fibers, such as cellulose, carbon, or polyester woven in the form of ordinary textile are coated with single-walled carbon nanotubes (SWNTs). See, Liangbing Hu, et al., “Stretchable, Porous, and Conductive Energy Textiles,” Nano Lett 10, 708 (2010). Each cotton fiber is comprised of multiple individual cotton fibrils, which are in turn composed of multiple micro-fibrils bundled together. This is done by “dipping and drying” of everyday textile into a solution of the nanotubes. The resulting material is a conductive textile. Super capacitors are made from these conductive textiles.

Still another example includes hybrid carbon nanotube/gold wires. Au nano wires are first grown inside the channels of commercially available AAO templates (nano pore) using electro-deposition. See, Manikoth M. Shaijumon et al., “Synthesis of Hybrid Nanowire Arrays and their Application as High Power Supercapacitor Electrodes,” Chem. Commun., 2373 (2008). After the electro-deposition of the Au nano wires, CVD is carried out to grow multi-walled carbon nanotubes (MWNTs) inside the template, by the pyrolysis of acetylene. The template is removed. The presence of an evaporated metal film prevents the CNT/Au nano wire hybrid structures from collapsing after the removal of the templates. However, these conventional capacitors are limited, since they are produced by either microelectronics growth mechanism or use already woven non-conducting complex patterns of textile fibers.

Supercapacitors have also been produced with In₂O₃ nanowire/carbon nanotube films. See, Chen et al., “Flexible and transparent supercapacitor based on In₂O₃ nanowire/carbon nanotube heterogeneous films.” These supercapacitors are planar based devices that have PET polymer separator films and two of the In₂O₃ nanowire/carbon nanotube heterogeneous films as electrodes.

Two of the present inventors and colleagues have (contemporaneously with the present work) constructed planar two dimensional sheet capacitors. See, Nayfeh et al., “Supercapacitor electrodes based on polyaniline-silicon nanoparticle composite,” Journal of Power Sources, Vol. 195 Issue 12, pp 3956-59. The capacitor electrodes in this paper were highly oriented pyrolytic graphite (HOGP) sheets. The present inventors have recognized that this types of super capacitors have limitations. One limitation is that the construction limits the physical configuration of the super capacitors to planar sheets.

### SUMMARY OF THE INVENTION

A one-dimensional super capacitor thread has a thin conductive wire electrode. An active layer of silicon nanoparticles and polyaniline surrounds the thin wire electrode. An electrolyte layer surrounds the active layer. The electrolyte layer can be a layer of polyvinyl alcohol (PVA).

### BRIEF DESCRIPTION OF THE DRAWINGS

FIG. 1 shows a cross-section of an example super capacitor thread according to an embodiment of the present invention;

FIGS. 2A and 2B are cross-sections of an example super capacitor according to an embodiment of the invention that was formed from two super capacitor threads according of FIG. 1;

FIG. 3 shows fabric with a super capacitor of the invention sewn into the fabric;

FIG. 4 shows charging-discharging curves of the example super capacitor.

### DETAILED DESCRIPTION OF THE PREFERRED EMBODIMENTS

The invention provides super capacitor threads, including single and multiple threads, which have a thin conductive wire electrode. An active layer of silicon nanoparticles and polyaniline surrounds the thin conductive wire electrode. An electrolyte layer surrounds the active layer. The electrolyte layer can be a layer of polyvinyl alcohol (PVA).

Preferred embodiments of the invention will now be discussed with respect to the drawings. The drawings may include schematic representations, which will be understood by artisans in view of the general knowledge in the art and the description that follows. Features may be exaggerated in the drawings for emphasis, and features may not be to scale.

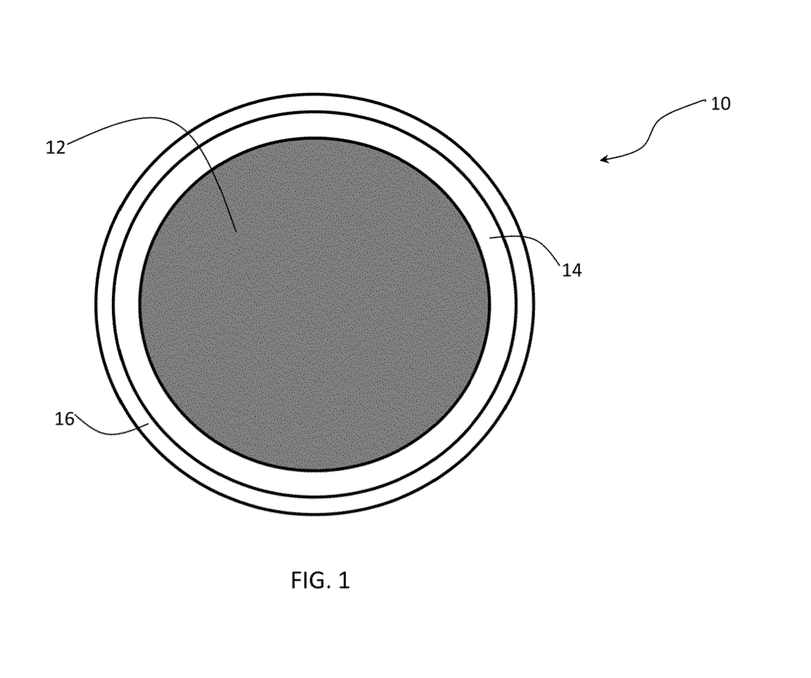

FIG. 1 shows an example super capacitor thread 10. The thread 10 includes an electrode 12 provided by a conductive wire, e.g., industrial metal wire. A first, active layer 14 surrounding the electrode 12 is provided by the active material, particularly ultrasmall silicon nanoparticles in polymers. A second, electrolyte layer 16 surrounding the first layer 14 is provided by, e.g., a solid electrolyte such as polyvinyl alcohol.

Prior examples discussed in the background, such as Chen et al., are planar based devices. Chen uses nanowires for planar devices. The invention uses an electrode 12 that can provide a super capacitor thread 10 in form of a long sewable thread. The electrode is not a nanowire, but is thick enough to be observable with human vision and can be handled routinely by layman or relatively low-skill industrial workers in a manufacturing process that does not require highly specialized skills such as are required for devices that use nanowires, carbon nanotubes or similar materials. Advantageously, the electrode 12 (and super capacitor thread 10) can be hundreds of meters long and use industrial metal material.

In preferred embodiments of the present invention, the conductive electrode 12 is realized with ultrafine conducting wires that are easily controllable through simple mechanical procedures of (for instance) knitting, patterning, weaving, etc., along with a wet/dry procedure for functionalizing the wire with super electrical properties. Wires that can be spooled to be coated in a process with the active materials and electrolyte can be used. Example ultrafine wires that are available on spools are sold by the California Fine Wire Company. Unlike devices using carbon nanotubes, super capacitor threads according to the present invention use ultra small silicon nanoparticles as the active medium in three dimensions. This allows the use of ultrafine wires. A nonlimiting example conductor for the electrode 12 is low cost ultrathin industrial bare metal. In other preferred embodiments, the electrode is a metal wire that is as small as half a micrometer in diameter. For flexible applications such as clothing, the upper limit is dictated by flexibility and thickness of the clothing.

It is believed that there is currently no super capacitor built using standard industrial metal wires. Stainless steels are an example metal for the conductive wires, as they have excellent ductility and are commercially available as round forms. Other suitable metals for the electrode wires include copper or nickel. The active material of layer 14 can be formed composites of ultra small (e.g., 3 nm) silicon nanoparticles embedded in polymers.

The super capacitor thread 10 can be of any length, including, for instance, up to hundreds of meters long. Further, it can be weaved or knitted to form stand-alone patterns, or patterns attached to substrates, including rigid or flexible substrates, according to preselected programming. The patterns can be integrated in (for instance) standard fabric manufacturing technologies in example embodiments to enable wearable recharging energy storage devices.

A super capacitor thread of the invention can be formed via a wet/dry treatment of the wires with a silicon nanoparticles cocktail mixture and insulating materials. A solution of silicon nanoparticles and polyaniline is prepared in water. The silicon nanoparticles can be provided via a number of methods. A nonlimiting example method forms silicon nanoparticles according to example techniques such as those disclosed in U.S. Pat. Nos. 6,585,947 and 6,743,406. Other polymers can be used as the electrolyte, such as but not limited to polyacetylene and polypyrrole. Also, instead of water, the silicon nanoparticles and polymer can be prepared in solvents such as alcohols.

Coating a conductive wire with the silicon nanoparticle-polyaniline solution can be accomplished by immersing the conductive wire in the silicon nanoparticle-polyaniline solution for a certain period of time (e.g., 1 minute), or by allowing or causing the conductive wire to pass through the solution. After coating the conductive wire with the solution, the coated wire is dried, for instance by putting the coated wire in air to allow the water content in the coating to evaporate. This results in the conductive wire being coated with the silicon nanoparticle composite, and completes the active layer.

After drying, the coating of the processed wire is immersed in a solution of electrolyte, such as polyvinyl alcohol (PVA). Other example electrolytes include polyethyleneoxide (PEO). An example solvent is water, but other solvents may include alcohols. The twice-coated wire is then dried, e.g., put in air for evaporation of water, which completes the electrolyte layer. The protective coating can also be formed over the thread, by standard wire coating processes.

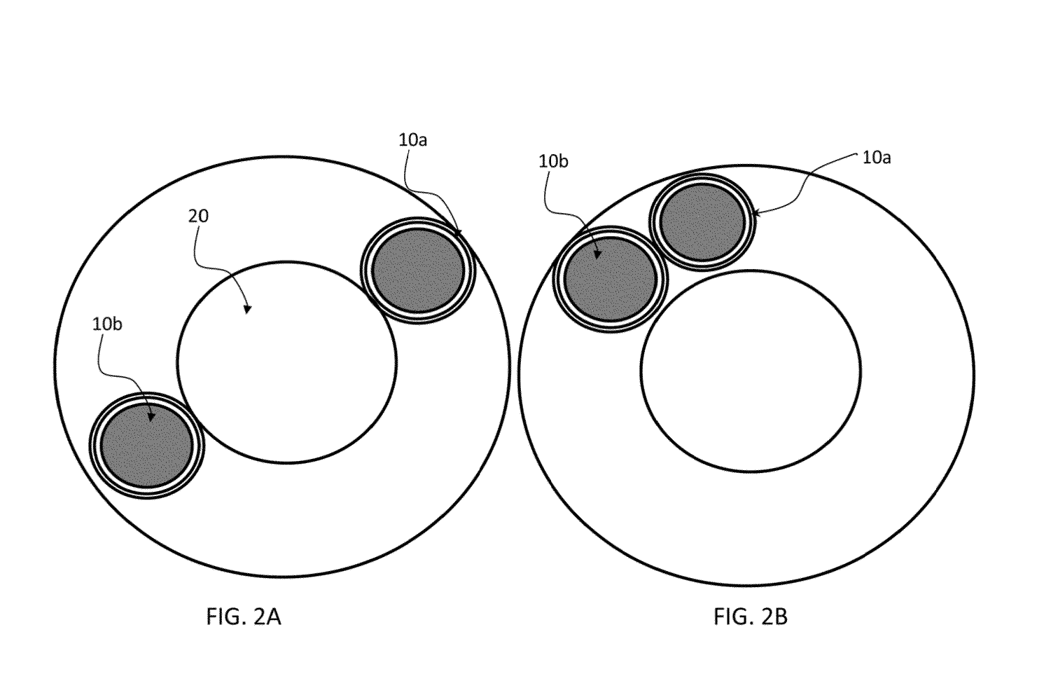

The example process provides a flexible, one-dimensional thread that is ready to be used (for instance) to construct fabrics by weaving or knitting using conventional standard technologies, or for any type of patterning. In a particular example embodiment, a super capacitor was formed by using a twisted pair 10a, 10b of super capacitor threads according to FIG. 1. The structure is shown in FIGS. 2A and 2B. These show cross sections a different axial points. The twisted nature will have the threads 10a and 10b in contact with each other over substantial portions of their length. A plastic thin film rod 20 of 0.5 mm diameter was used as a support, although the threads could also be wrapped as a standards twisted pair without a central rod. The entire structure of the twisted pair was coated again with a protective outer coating 22 of PVA. After the coating, the plastic rod support can be removed. Alternatively, the super capacitor threads can be twisted about each other without the plastic supporting rod.

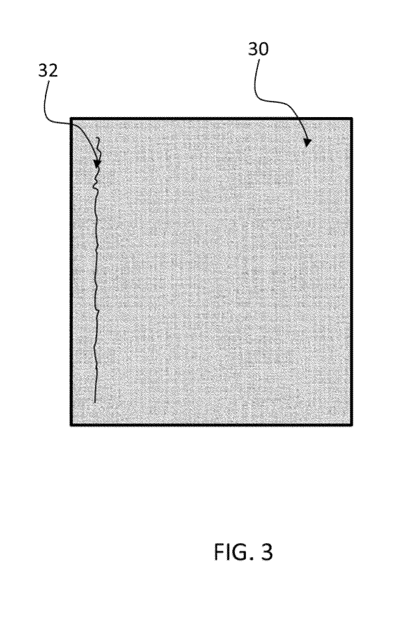

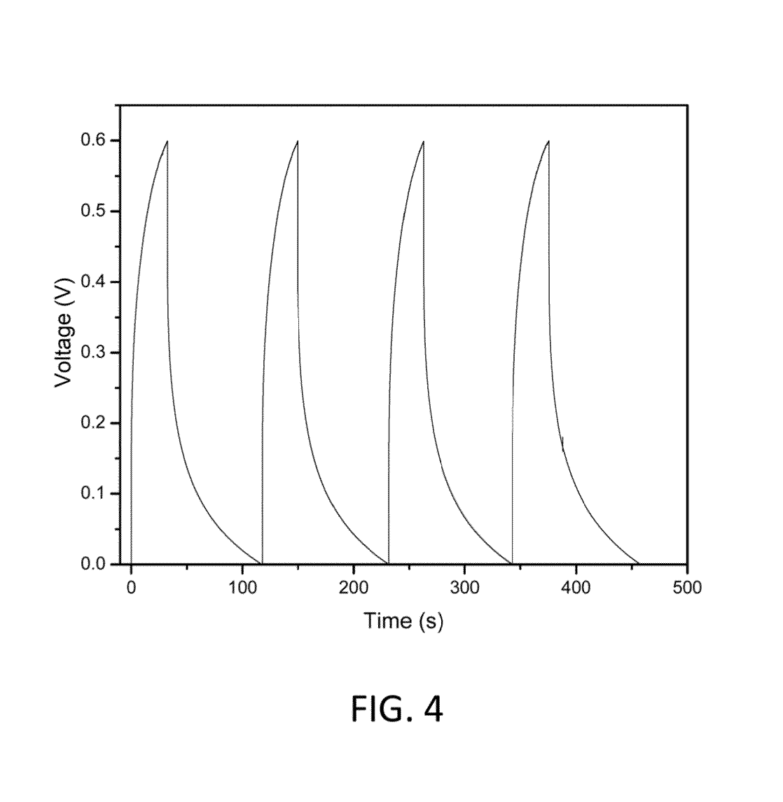

In another example embodiment, the super capacitor thread is knitted into an article of clothing, for instance a pocket of a household shirt. In an example method, a simple stainless steel needle was used to test the supercapacitor thread's ability to be employed in a like mannter to clothing threads. Two contacts, e.g., clip contacts, were bonded to the super capacitor for connection to external devices. A shirt having a super capacitor thread device knitted therein around its front pocket was used. This is shown in FIG. 3, where a fabric 30 includes a super capacitor 32 that is dimensions to be comparable to standard clothing thread and is sewn into the fabric. This was demonstrated experimentally. In this form, the supercapacitor could provide power source for portable wearable devices. Those of ordinary skill in the art will also appreciate that the super capacitor can be used in any of various circuits. Example embodiments have utility in, as nonlimiting examples, energy, electronics, and consumer industries. FIG. 4 shows charging-discharging curves of an example experimental super capacitor, which confirm the operation of the capacitor.

Super capacitor threads of the invention can be manufactured in an assembly line process. A first dispensing spool (e.g., industrial spool of ultrafine metal wire) is transferred to a second intake spool, such as by selective rotation of the spools using an actuator such as a driven motor (not shown) suitably coupled to one or both spools. The wire thread passes through a container of the active solution that is disposed between the spools. The spooling process is repeated with the wire having the active layer then pass through a second container having the electrolyet solution. The inter distances of the configuration and the speed of the thread are selected to allow enough (prescribed) thicknesses of the nanoparticles-polymer composite and the PVA electrolyte to build while at the same time allow drying of the layers. Individual threads are then twisted together to form a capacitor, with or without a supporting core as in FIGS. 2A and 2B.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A one-dimensional super capacitor thread comprising:
a thin conductive wire electrode;
an active layer surrounding said electrode, said active layer comprising a composite of silicon nanoparticles and polyaniline; and
an electrolyte layer surrounding said active layer.

2. A super capacitor, comprising at least two one-dimensional super capacitor threads of claim 1 arranged adjacent each other.

3. The super capacitor of claim 2, wherein the at least two one-dimensional super capacitor threads are arranged as a twisted pair.

4. The super capacitor of claim 3, wherein the twisted pair is wrapped around a core and the super capacitor further comprises a protective coating.

5. The super capacitor thread of claim 1, wherein said electrolyte layer comprises a layer of polyvinyl alcohol (PVA).

6. The super capacitor of claim 4, further comprising:
an additional electrolyte layer surrounding said twisted pair.

7. A material comprising:
a fabric; and
the super capacitor of claim 2 woven or knitted into said fabric.

8. The super capacitor of claim 2, having dimensioned as clothing thread.

9. The super capacitor of claim 2, wherein the said electrode comprises one of stainless steel, copper or nickel.

10. A method for making a super capacitor thread, the method comprising:
providing an active solution of silicon nanoparticles and polyaniline in water;
first coating a thin conductive wire with said provided active solution;
drying the first coated thin conductive wire;
second coating the dry thin conductive wire with a solution of solid electrolyte;
drying the second coated thin conductive wire.

11. The method of claim 10, wherein the solution of solid electrolyte comprises polyvinyl alcohol (PVA) in water.
